(19) United States
(12) Patent Application Publication
(10) Pub. No.: US 2014/0220306 A1
(43) Pub. Date: Aug. 7, 2014

(54) TRANSPARENT FILM HAVING MICRO-CONVEXOCONCAVE STRUCTURE ON SURFACE THEREOF, METHOD FOR PRODUCING THE SAME, AND BASE FILM USED IN PRODUCTION OF TRANSPARENT FILM

(71) Applicant: Mitsubishi Rayon Co., Ltd., Tokyo (JP)

(72) Inventors: Masayuki Uchida, Otake-shi (JP); Katsuhiro Kojima, Yokohama-shi (JP); Tetsuya Jigami, Otake-shi (JP)

(21) Appl. No.: 14/343,077

(22) PCT Filed: Sep. 7, 2012
(86) PCT No.: PCT/JP2012/072881

§ 371 Date: Mar. 6, 2014

(30) Foreign Application Priority Data
Sep. 8, 2011 (JP) 2011-195998

(51) Int. Cl. B32B 3/26; B29C 37/00

(52) U.S. Cl. CPC B32B 3/263; B29C 37/0053
USPC 428/172; 264/494

(57) ABSTRACT

The present invention relates to a transparent film having a cured layer, wherein the cured layer having a micro-convexoconcave structure with the average period of a convex section or a concave section of 20 nm to 400 nm is formed on a rough surface of a base film obtained from an acrylic resin having a rough surface in which a maximum valley depth (Pv) is 0.1 to 3 μm and an average length (RSm) of a contour curve element is 10 μm or less; and the number of lattice in the cured layer adhered to the base film is 51 or more when a cross cut test is performed using 100 lattices at an interval of 2 mm.

### TECHNICAL FIELD

The present invention relates to a transparent film having a micro-convexoconcave structure on a surface thereof, a method for producing the same, and a base film used in production of the transparent film.

This application claims the priority benefit of Japanese Patent Application No. 2011-195998 filed in Japan on Sep. 8, 2011, and the content of which is incorporated herein by reference.

### BACKGROUND ART

In recent years, it has been known that a product having a micro-convexoconcave structure with a period equal to or less than a wavelength of visible light on its surface exhibits an anti-reflective effect, a lotus effect, or the like. Particularly, it has been known that the convexoconcave structure, referred to as a moth eye structure, acts as an effective anti-reflective means by continuously increasing the refractive index from the refractive index of air to the refractive index of the material of a product.

A product having a micro-convexoconcave structure on a surface thereof is obtained by, for example, attaching a transparent film having a micro-convexoconcave structure on a surface thereof (hereinbelow, the “transparent film having a micro-convexoconcave structure on a surface thereof” is simply described as a “transparent film”) on a surface of a main body of a product.

As a method for producing a transparent film, a method having the following steps (i) to (iii) is known, for example (for example, Patent Document 1).

(i) A step of sandwiching an active energy ray-curable resin composition between a mold having an inverted structure of a micro-convexoconcave structure on a surface thereof and a base film serving as a main body of the transparent film.

(ii) A step of irradiating the active energy ray-curable resin composition with an active energy ray to cure the same, thus forming a cured layer having a micro-convexoconcave structure and obtaining a transparent film.

(iii) A step of separating the transparent film and the mold.

A film for optical use is generally used as the base film. However, since the film for optical use is required to have high transparency (high transmittance, low haze), it has a smoothly finished surface. For such reasons, there are the occasions in which the adhesiveness at an interface between the base film and cured layer is insufficient and peeling occurs at an interface between the base film and cured layer in the aforementioned step (iii), and thus the cured layer may not be separated from the mold. Further, even when the separation can be made from the mold, the adhesiveness between the base film and cured layer may not be sufficient. In particular, when a film composed of an acrylic resin is used as a base film, it is difficult to have adhesiveness between the surface of the base film and the cured layer.

To improve poor release or poor adhesion described above, a production method using a base film with roughened surface has been suggested (Patent Document 2). When the refractive index of an active energy ray-curable resin composition is the same as that of the base film so that each layer is closely adhered to each other, the interface is not generally seen. However, when there is a dent which is unnecessarily deep, the active energy ray-curable resin composition cannot be incorporated to the dent so that an appearance defect may be caused according to this method as it is caused by a difference in refractive index between air remaining in the dent and the material of a base film or a cured layer.

In particular, since a transparent film having a micro-convexoconcave structure with a period equal to or less than a wavelength of visible light on its surface has a high anti-reflective performance and high transparency, there may be a case in which defects not found with a naked eye in a conventional optical film become more prominent. Thus, for a transparent film having a micro-convexoconcave structure with a period equal to or less than a wavelength of visible light on its surface, it is necessary that the convexoconcaves on a base film are fully filled in a cured layer so that no air is left in a dent.

### CITATION LIST

### Patent Document

Patent Document 1: JP 2007-076089 A
Patent Document 2: JP 2010-201641A

### DISCLOSURE OF THE INVENTION

### Problem to be Solved by the Invention

The present invention provides a transparent film having excellent adhesiveness at an interface between a cured layer having a micro-convexoconcave structure and a base film and also good appearance quality, a method for stable production of the transparent film, and a base film having excellent adhesiveness with a cured layer having a micro-convexoconcave structure and also a rough surface allowing easy incorporation of an active energy ray-curable resin composition to a dent.

### Means for Solving Problems

(1) One embodiment of the transparent film of the present invention is a transparent film including a cured layer, in which the cured layer having a micro-convexoconcave structure with the average period of the convex section or concave section of 20 nm to 400 nm is formed on a rough surface of a base film obtained from an acrylic resin having a rough surface in which a maximum valley depth (Pv) is 0.1 to 3 μm according to the JIS B 0601: 2001, and an average length (RSm) of a contour curve element is 10 μm or less according to the JIS B 0601: 2001, and the number of lattice in the cured layer adhered to the base film is 51 or more when a cross cut test is performed according to the JIS K 5400 using 100 lattices at an interval of 2 mm.

(2) One embodiment of the method for producing a transparent film of the present invention is a method for producing a transparent film with a cured layer having a micro-convexoconcave structure formed on a surface of a base film, in which the method has (I) a step of sandwiching an active energy ray-curable resin composition between a rough surface of a base film obtained from an acrylic resin having a rough surface in which a maximum valley depth (Pv) according to the JIS B 0601: 2001 is 0.1 to 3 μm, and an average length (RSm) of a contour curve element according to the JIS B 0601: 2001 is 10 μm or less and a surface of a mold having an inverted structure of the micro-convexoconcave structure, (II) a step of irradiating the active energy ray-curable resin composition with an active energy ray to cure the active energy ray-curable resin composition, thus forming a cured layer and obtaining a transparent film, and (III) a step of separating the transparent film and the mold.

(3) With regard to the step (II) of the aforementioned (2), it is preferable that the surface temperature of the mold be 70° C. or higher at the time of curing the active energy ray-curable resin composition and also viscosity be lowered by using a bi-functional monomer, a mono-functional monomer, or the like having a low viscosity as the penetration property and anchor effect for the base film can be improved by lowering the viscosity of the active energy ray-curable resin composition.

(4) The mold for the aforementioned (2) or (3) preferably has, on its surface, a micro-convexoconcave structure in which the average period of the convex section or concave section is 20 nm to 400 nm.

(5) The micro-convexoconcave structure of the mold in the aforementioned (4) is preferably anode oxidized porous alumina.

(6) One embodiment of the base film of the present invention is a base film obtained from an acrylic resin that is used for producing a transparent film with a cured layer having a micro-convexoconcave structure formed on its surface, in which the base film has a rough surface with the maximum valley depth (Pv) of 0.1 to 3 μm according to the JIS B 0601: 2001, and the average length (RSm) of a contour curve element of 10 μm or less according to the JIS B 0601: 2001.

### Effect of the Invention

The transparent film of the present invention has excellent adhesiveness at an interface between a cured layer having a micro-convexoconcave structure and a base film and also has good appearance quality.

According to the method for producing a transparent film of the present invention, a transparent film having excellent adhesiveness at an interface between a cured layer having a micro-convexoconcave structure and a base film and also good appearance quality can be produced stably.

The base film of the present invention has excellent adhesiveness with a cured layer having a micro-convexoconcave structure and also has a rough surface allowing easy incorporation of an active energy ray-curable resin composition to a dent.

### BRIEF DESCRIPTION OF DRAWINGS

FIG. 1 is a cross-sectional view illustrating the process for producing a mold having anode oxidized porous alumina on its surface.

FIG. 2 is a schematic drawing illustrating one example of the apparatus for producing a transparent film.

FIG. 3 is a cross-sectional view illustrating one example of the transparent film.

FIG. 4 is a schematic drawing illustrating one example of the scratch blast apparatus for performing roughening of the surface of a base film.

### BEST MODE(S) FOR CARRYING OUT THE INVENTION

As described herein, “(meth)acrylate” means acrylate or methacrylate, “transparent” means transmission of at least light with a wavelength of 400 to 1170 nm, and “active energy ray” means visible light, ultraviolet ray, electron beam, plasma, heat ray (infrared ray and the like), and the like.

### <Method for Producing Transparent Film>

The method for producing a transparent film of the present invention is a method for producing a transparent film with a cured layer having a micro-convexoconcave structure formed on a surface of a base film, and it has the following steps (I) to (III).

(I) A step of sandwiching an active energy ray-curable resin composition between a surface of a base film and a surface of a mold having an inverted structure of a micro-convexoconcave structure on the surface thereof.

(II) A step of irradiating the active energy ray-curable resin composition with an active energy ray to cure the active energy ray-curable resin composition, thus forming a cured resin layer and obtaining a transparent film.

(III) A step of separating the transparent film and the mold.

### (Base Film)

With regard to the base film of the present invention, a film obtained from an acrylic resin is used from the viewpoint of having excellent transparency.

A surface of the base film is roughened. Hereinbelow, the roughened surface is described as a rough surface.

The maximum valley depth Pv of the rough surface of the base film is 0.1 to 3 μm, preferably 0.1 to 2.8 and more preferably 1 to 2.6 μm.

The average length RSm of a contour curve element of the rough surface of the base film is 10 μm or less, preferably 9.5 μm or less, and more preferably 8.5 μm or less.

When the maximum valley depth Pv is 0.1 μm or more and the average length RSm of a contour curve element is 10 μm or less, sufficient adhesiveness to a cured layer is obtained due to irregularities on the surface of the base film. When the maximum valley depth Pv is 3 μm or less, the irregularities on the surface of the base film are not excessively deep so that appearance defect of the transparent film is suppressed.

The maximum valley depth Pv and the average length RSm of a contour curve element are based on JIS B 0601: 2001, and they can be measured by scanning type white light interferometry. Specifically, the surface observation is performed by using a scanning type white light interferometer three-dimensional profiler system “New View 6300” (manufactured by Zygo Corporation), visible ranges are connected to each other to have a size of 4 mm×0.5 mm, and the calculation is made based on the observation result.

Examples of the method for roughening the base film include a blast treatment, an embossing processing, a corona treatment, and a plasma treatment.

The blast treatment is a method for forming an irregular shape by carving the surface of a base film. Examples of the blast treatment include sand blast by which the surface is carved by applying sand on a surface of a base film, scratch blast by which an irregular shape is obtained by scratching a surface of a base film using a needle with an acute angle, hair line processing, and the like.

The embossing processing is a method for forming an irregular shape by sandwiching a thermoplastic resin in molten state between a mirror roll and an embossing roll followed by cooling.

The corona treatment is a method for surface modification in which corona discharge is generated by applying high frequency-high voltage output supplied from a high frequency power source between a discharge electrode and a processing roll and a base film is passed through under corona discharge.

The plasma treatment is a method for surface modification in which gas is excited in vacuum using a high frequency power source as a trigger to prepare it in a plasma state with high reactivity and it is brought into contact with a base film.

As for the roughening method, from the viewpoint of forming a dense irregular shape, a blast treatment such as a scratch blast or a hair line processing, or an embossing processing is preferable.

As for the base film, a film obtained from an acrylic resin which has a difference in refractive ratio within ±0.05 compared to a cured layer is preferably used. A film obtained from an acrylic resin which has a difference in the refractive ratio within ±0.03 compared to a cured layer is preferably used. As described herein, the refractive index indicates refractive index at wavelength of 589.3 nm at 23° C.

When a difference in the refractive ratio is within ±0.05 between the base film and the cured layer, reflection or scattering is sufficiently suppressed at an interface between the base film and cured layer even when irregularities are formed on a surface of the base film, and thus the haze of the transparent film itself is sufficiently lowered and the high transparency can be maintained.

The dynamic viscoelasticity loss coefficient (tan δ) of a base film before surface roughening is preferably 80 to 110° C., and more preferably 80 to 105° C. tan δ is based on the standard of JIS K 7244-4. When tan δ is 80° C. or higher, heat resistance is improved. When tan δ is 110° C. or lower, the active energy ray-curable resin composition can more easily penetrate into a base film, and thus the adhesiveness to the cured layer is further improved.

Total light transmittance of the base film before surface roughening is preferably 90% or more, and the haze is preferably 2% or less. More preferably, the total light transmittance is 91% or more and the haze is 1.5% or less. Further, the total light transmittance is preferably 92% or more, and the haze is preferably 1.0% or less. The total light transmittance is based on the standard of JIS K 7361-1.

When the total light transmittance is 90% or more and the haze is preferably 2% or less, sufficient transparency is obtained so that optical performances that are required for an optical film (diffusion film, anti-reflection film, or the like) can be fully exhibited. Examples of the base film include “TEKUNOROI” manufactured by Sumitomo Chemical Company, Limited, “SO Film” manufactured by KURARAY CO., LTD, “ACRYVIEWA” manufactured by Nippon Shokubai Co., Ltd, and “ACRYPLEN” manufactured by Mitsubishi Rayon Co., Ltd.

Before the surface roughening, transmittance for light with wavelength of 365 nm is preferably 10% or more, more preferably 30% or more, and even more preferably 50% or more. When the transmittance for light with wavelength of 365 nm is 10% or more, the active energy ray-curable resin composition can be fully cured by irradiation with UV light from the base film side.

The base film may be either a monolayer film or a laminated film.

With regard to a material for the base film, when a composition containing an acrylic monomer as a main component is used as an active energy ray-curable resin composition, an acrylic resin is preferably used from the viewpoint of having sufficiently low difference in a refractive index between the base film and the cured layer.

As for the acrylic resin, (C) the acrylic resin composition containing 0 to 80% by mass of (A) the acrylic resin and 20 to 100% by mass of (B) the rubber-containing polymer listed below is preferable. When the amount of (B) the rubber-containing polymer is excessively small, tensile strength of an acrylic film is lowered. Further, the adhesiveness to the cured layer tends to be lowered.

(A) The acrylic resin is a homopolymer or a copolymer consisting of 50 to 100% by mass of a unit derived from alkyl methacrylate having an alkyl group with 1 to 4 carbon atoms and 0 to 50% by mass of a unit derived from other vinyl monomer which is copolymerizable with it.

As for the alkyl methacrylate having an alkyl group with 1 to 4 carbon atoms, methyl methacrylate is most preferable.

Examples of other vinyl monomer include alkyl acrylate (methyl acrylate, ethyl acrylate, butyl acrylate, propyl acrylate, 2-ethylhexyl acrylate, or the like), alkyl methacrylate (butyl methacrylate, propyl methacrylate, ethyl methacrylate, methyl methacrylate, or the like), an aromatic vinyl compound (styrene, α-methylstyrene, paramethyl styrene, or the like), and a vinyl cyan compound (acrylonitrile, methacrylonitrile, or the like).

(A) The acrylic resin can be produced by a known suspension polymerization, emulsion polymerization, bulk polymerization, or the like.

(A) The acrylic resin can be obtained as DAIANAL (registered trademark) BR series manufactured by Mitsubishi Rayon Co., Ltd. or ACRYPET (registered trademark) manufactured by Mitsubishi Rayon Co., Ltd.

The rubber polymer indicates a polymer having glass transition temperature (Tg) of lower than 25° C. Tg can be calculated from FOX's equation by using the values described in Polymer H and Book (J. Brandrup, Interscience, 1989).

(B) The rubber-containing polymer can be those polymerized with two or more steps. Examples of (B) the rubber-containing polymer include the rubber-containing polymers described in JP 2008-208197 A, JP 2007-327039 A, JP 2006-289672 A, or the like.

Specific examples of (B) the rubber-containing polymer include the following polymer (B1) to (B3).

Polymer (B 1): Polymer obtained by polymerizing the monomer (B 1-2) obtained by having, at least as a constitutional component, an alkyl methacrylate with an alkyl group having 1 to 4 carbon atoms in the presence of a rubber polymer obtained by polymerizing the monomer (B 1-1) obtained by having, at least as a constitutional component, an alkyl acrylate with an alkyl group having 1 to 8 carbon atoms and/or an alkyl methacrylate with an alkyl group having 1 to 4 carbon atoms, and a graft cross-linking agent. Each of the monomer (B 1-1) and (B 1-2) may be subjected to batch polymerization or it may be polymerized with two or more divided steps.

Polymer (B2): It is a polymer obtained by the following steps.

(1) In the presence of a polymer obtained by polymerizing the monomer (B2-1) obtained by having, at least as a constitutional component, an alkyl acrylate with an alkyl group having 1 to 8 carbon atoms and/or an alkyl methacrylate with an alkyl group having 1 to 4 carbon atoms, and a graft cross-linking agent

(2) a rubber polymer is obtained by polymerizing the monomer (B2-2) having a composition which is different from the monomer (B2-1) and obtained by having, at least as a constitutional component, an alkyl acrylate with an alkyl group having 1 to 8 carbon atoms and/or an alkyl methacrylate with an alkyl group having 1 to 4 carbon atoms, and a graft cross-linking agent, and in the presence thereof,

(3) the monomer (B2-3) obtained by having, at least as a constitutional component, an alkyl methacrylate with an alkyl group having 1 to 4 carbon atoms is polymerized.

Polymer (B3): It is a polymer obtained by the following steps.

(1) A polymer is obtained by polymerizing the monomer (B3-1) obtained by having, at least as a constitutional component, an alkyl acrylate with an alkyl group having 1 to 8 carbon atoms and/or an alkyl methacrylate with an alkyl group having 1 to 4 carbon atoms, and a graft cross-linking agent, and in the presence thereof,

(2) a rubber polymer is obtained by polymerizing the monomer (B3-2) obtained by having, at least as a constitutional component, an alkyl acrylate with an alkyl group having 1 to 8 carbon atoms and a graft cross-linking agent, and in the presence thereof,

(3) the monomer (B3-3) obtained by having, at least as a constitutional component, an alkyl acrylate with an alkyl group having 1 to 8 carbon atoms and/or an alkyl methacrylate with an alkyl group having 1 to 4 carbon atoms, and a graft cross-linking agent is polymerized, and also

(4) the monomer (B3-4) obtained by having, at least as a constitutional component, an alkyl methacrylate with an alkyl group having 1 to 4 carbon atoms is polymerized.

For production of (B) the rubber-containing polymer, together with an alkyl acrylate with an alkyl group having 1 to 8 carbon atoms and an alkyl methacrylate with an alkyl group having 1 to 4 carbon atoms, a vinyl monomer or a polyfunctional monomer copolymerizable with them can be also used, if necessary. In order to lower deterioration of the rubber polymer caused by UV light, a monomer containing benzene ring (styrene, alkyl substituted styrene, or the like) is preferably not used.

For production of (B) the rubber-containing polymer, the amount of a monomer or a mixture of monomer containing an alkyl methacrylate as a main component for polymerization in the presence of the rubber polymer is, from the viewpoint of the tensile strength of an acrylic film, preferably 60 parts by mass or more compared to 100 parts by mass of the rubber polymer. When the amount of the monomer or the mixture of monomer is 60 parts by mass or more, dispersability of (B) the rubber-containing polymer is improved and the transparency of an acrylic film to be obtained is enhanced. The amount of the monomer or the mixture of monomer is more preferably 100 parts by mass or more, and preferably 150 parts by mass or more. The amount of the monomer or the mixture of monomer is preferably 400 parts by mass or less compared to 100 parts by mass of the rubber polymer from the viewpoint of the tensile strength of an acrylic film.

For production of (B) the rubber-containing polymer, the difference in a refractive index of the polymer consisting of a monomer or a mixture of monomer used for each step is preferably 0.05 or less, and more preferably 0.03 or less. By selecting the type and ratio of the monomer used for each step such that the difference in the refractive index is 0.05 or less, an acrylic film having high transparency can be obtained. For example, in case of a three-step polymer, when the refractive index of a polymer consisting of a monomer used for each step is na, nb, and nc, each of the absolute value of na−nc, the absolute value of nb−nc, and the absolute value of nb−nc is preferably 0.02 or less.

With regard to (B) the rubber-containing polymer, the refractive index value of a homopolymer at 20° C. (polymethyl methacrylate: 1.489, poly n-butyl acrylate: 1.466, polystyrene: 1.591, polymethyl acrylate: 1.476, or the like), which is described in “POLYMER HANDBOOK” (Wiley Interscience), is used as the refractive index of the polymer in each step. Further, the refractive index of the copolymer can be calculated based on its volume ratio. The specific gravity used therefor is as follows: polymethyl methacrylate; 0.9360, poly n-butyl acrylate; 0.8998, polystyrene; 0.9060, polymethyl acrylate; 0.9564, and the like.

As for the method for producing (B) the rubber-containing polymer, a successive multi-step polymerization is preferable. Examples of other production method include emulsifying suspension polymerization which includes converting into a suspension polymerization system at the time of polymerizing each polymer after emulsion polymerization.

Examples of the surfactant used for preparing an emulsifying liquid include an anionic, a cationic, and a non-ionic surfactant. The anionic surfactant is preferable. Examples of the anionic surfactant include rosin soap; potassium oleate; carboxylate salt such as sodium stearate, sodium myristate, sodium N-lauroyl sarcosinate, or dipotassium alkenyl succinate; sulfate ester salt such as sodium lauryl sulfate; sulfonate salt such as sodium diocyl sulfosuccinate, sodium dodecylbenzene sulfonate, and sodium alkyldiphenyl ether disulfonate; phosphate ester salt such as sodium polyoxyethylene alkyl phenyl ether phosphate; and phosphate ester salt such as sodium polyoxyethylene alkyl ether phosphate. Among them, from the viewpoint of preserving an ecological system, phosphate ester salt such as sodium polyoxyethylene alkyl ether phosphate is preferable.

Specific examples of the surfactant include “NC-718” manufactured by Sanyo Chemical Industries, Ltd., “PHOSPHANOL LS-529”, “PHOSPHANOL RS-610NA”, “PHOSPHANOL RS-620NA”, “PHOSPHANOL RS-630NA”, “PHOSPHANOL RS-640NA”, “PHOSPHANOL RS-650NA”, and “PHOSPHANOL RS-660NA” manufactured by TOHO Chemical Industry Co., Ltd., and “LATEMUL P-0404”, “LATEMUL P-0405”, and “LATEMUL P-0406”, “LATEMUL P-0407” manufactured by Kao Corporation (all trade names).

Examples of the method for preparing an emulsifying liquid include a method of adding a monomer to water followed by adding a surfactant, a method of adding a surfactant to water followed by adding a monomer, and a method of adding a surfactant to a monomer followed by adding water. Among them, the method of adding a monomer to water followed by adding a surfactant and method of adding a surfactant to water followed by adding a monomer are preferred as a method for obtaining (B) the rubber-containing polymer.

As for the mixing device for preparing an emulsifying liquid obtained by mixing a monomer to give first-step polymer for constituting (B) the rubber-containing polymer, water, and a surfactant, a stirrer equipped with a stirring wing; various direct emulsifying devices such as homogenizer or homomixer; and a membrane emulsifying device can be mentioned.

The emulsifying liquid may have any dispersion structure such as W/O type and O/W type, and the O/W type containing oil droplets of monomer dispersed in water in which the diameter of the oil droplet in a dispersion phase is 100 μm or less is preferable.

Examples of the polymerization initiator include those already known in the field, and peroxide, an azo-based initiator, or a redox-based initiator in which an oxidizing agent and a reducing agent are combined is preferable. A redox-based initiator is more preferable, and a sulfo xylate-based initiator in which ferrous sulfate disodium ethylene diamine tetraacetate-rongalite-hydroperoxide are combined is particularly preferable.

As for the method of adding a polymerization initiator, a method of adding it to any one or both of an aqueous phase and a monomer phase can be employed.

(B) The rubber-containing polymer can be produced by collecting the rubber-containing polymer from a polymer latex produced by the method described above. As for the method for collecting (B) the rubber-containing polymer from a polymer latex, a method such as salting-out, acid-precipitating aggregation, spray dry, or freeze dry can be mentioned. (B) The rubber-containing polymer is generally collected in a powder phase.

The mass average particle diameter of (B) the rubber-containing polymer in powder phase is preferably 0.01 to 0.5 μm. From the viewpoint of the transparency of an acrylic film for optical use, it is preferably 0.3 μm or less, and more preferably 0.15 μm or less.

(C) The acrylic resin composition may contain, if necessary, a blending agent such as an UV absorbing agent, a stabilizing agent, a lubricating agent, a processing aid, a plasticizing agent, an anti-impact aid, or a release agent.

Examples of the method of adding a blending agent include a method of supplying it together with (C) the acrylic resin composition to a molding machine at the time of molding an acrylic film and a method of kneading and mixing a mixture in which (C) the acrylic resin composition is added in advance with a blending agent by using various kneaders. As for the kneader used for the latter method, a common mono-axial extruder, a bi-axial extruder, a banburry mixer, and a roll kneader can be mentioned.

Examples of the method for producing an acrylic film include a melt extrusion method such as a known melt casting method, a T die method, and an inflation method. From the viewpoint of economic feasibility, the T die method is preferable.

The thickness of the acrylic film is preferably 10 to 500 μM from the viewpoint of the physical properties of a film. When the thickness of the acrylic film is 10 to 500 μm, suitable rigidity is obtained, and thus production of a transparent film using a roll shape mold which will be described later can be easily performed and also the production of a film can be easily achieved as the film forming capability is stabilized. The thickness of the acrylic film is more preferably 15 to 400 μm, and even more preferably 20 to 300 μm.

### (Mold)

The mold has, on a surface of the main body of the mold, an inverted structure corresponding to the micro-convexoconcave structure on a surface of the transparent film to be finally obtained (hereinbelow, described as an inverted micro-convexoconcave structure).

Examples of the material of the main body of the mold include metals (including those with a surface on which an oxide film has been formed), quartz, glass, resins, and ceramics.

Examples of the shape of the main body of the mold include a roll shape, a cylinder shape, a flat plate shape, and a sheet shape.

Examples of the method for producing the mold include methods (X) and (Y) to be described below. Among them, from the viewpoint of the possibility of obtaining a large area of the mold and simplification of the manufacture, the method (X) is preferred.

(X) A method of forming anode oxidized porous alumina having a plurality of fine pores (recesses) on a surface of the main body of the mold made of alumina.

(Y) A method of forming an inverted micro-convexoconcave structure directly on a surface of the main body of the mold by using lithography, electron beam lithography, or laser light interferometry.

As for the method (X), a method including the following step (a) to (f) is preferable.

(a) a step of forming an oxide film by anode oxidation of aluminum in an electrolyte liquid under a constant voltage,

(b) a step of removing the oxide film and forming anode oxidized fine pore-generating points,

(c) a step of forming an oxide film having fine pores at the fine pore-generating points by performing again the anode oxidation of the aluminum in an electrolyte liquid,

(d) a step of enlarging a diameter of the fine pores,

(e) a step of performing again the anode oxidation in an electrolyte liquid after the step (d), and

(f) a step of repeating the steps (d) and (e).

### Step (a):

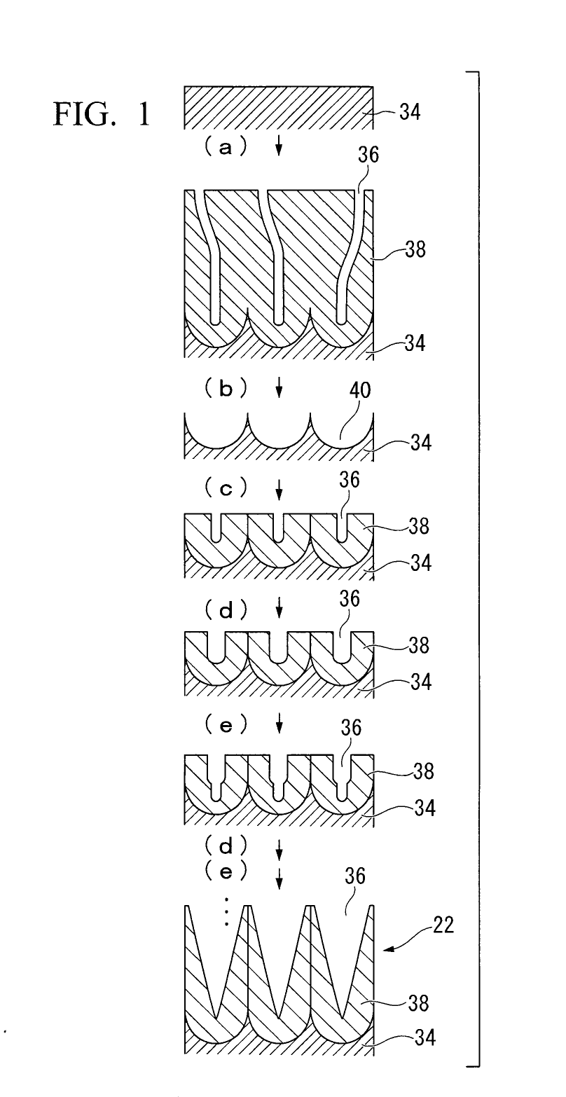

As illustrated in FIG. 1, when the aluminum 34 is subjected to anode oxidation, the oxide film 38 having fine pores 36 is foamed.

The purity of the aluminum is preferably 99% or more, more preferably 99.5% or more, and particularly preferably 99.8% or more. When the purity of aluminum is low, during the anode oxidation, an uneven structure with a size allowing scattering visible light is formed due to segregation of the impurities, or the regularity of the fine pores obtained by the anode oxidation may be lowered.

Examples of the electrolyte liquid include oxalic acid and sulfuric acid.

In the case of using oxalic acid as the electrolyte liquid:

The concentration of the oxalic acid is preferably 0.7 M or less. When the concentration of the oxalic acid exceeds 0.7 M, the current value becomes excessively high so that the surface of the oxide film may become rough.

When the formation voltage is 30 to 60 V, anode oxidized porous alumina having fine pores with high regularity at period of 100 nm can be obtained. Whether the formation voltage is higher or lower than this range, the regularity tends to decrease.

The temperature of the electrolyte liquid is preferably 60° C. or lower and more preferably 45° C. or lower. When the temperature of the electrolyte liquid exceeds 60° C., a so-called “thermal deterioration” phenomenon occurs, and thus the fine pores are damaged or the regularity of the fine pores is disrupted due to melting of the surface.

In the case of using sulfuric acid as the electrolyte liquid:

The concentration of the sulfuric acid is preferably 0.7 M or less. When the concentration exceeds 0.7 M, the current becomes excessively high so that it may be impossible to maintain a constant voltage.

When the formation voltage is 25 to 30 V, anode oxidized porous alumina having fine pores with high regularity at period of 63 nm may be obtained. When the formation voltage is higher or lower than this range, the regularity tends to decrease.

The temperature of the electrolyte liquid is preferably 30° C. or lower and more preferably 20° C. or lower. When the temperature of the electrolyte liquid exceeds 30° C., a so-called “thermal deterioration” phenomenon occurs so that the fine pores are damaged or the regularity of the fine pores is disrupted due to melting of the surface.

### Step (b):

As illustrated in FIG. 1, once the oxide film 38 is removed to form anode oxidized fine pore-generating points 40, the regularity of the fine pores can be improved.

Examples of the method of removing the oxide film include a method of removing the oxide film by dissolving the oxide film in a solution that selectively dissolves the oxide film while not dissolving the aluminum. Examples of such kind of solution include a mixture of chromic acid/phosphoric acid.

### Step (c):

As illustrated in FIG. 1, when the aluminum 34 from which the oxide film has been removed is subjected again to anode oxidation, the oxide film 38 having cylindrical fine pores 36 is formed.

The anode oxidation may be performed under the same conditions as the step (a). As the anode oxidation time is longer, the deeper fine pores can be obtained.

### Step (d):

As illustrated in FIG. 1, a treatment for enlarging the diameter of the fine pores 36 (hereinbelow, referred to as a fine pore diameter-enlarging treatment) is performed. The fine pore diameter-enlarging treatment is a treatment in which the diameters of the fine pores obtained by anode oxidation are enlarged by immersing the oxide film in a solution that dissolves the oxide film. Examples of such kind of solution include an aqueous phosphoric acid solution of about 5% by mass.

The longer the time for the fine pore diameter-enlarging treatment is, the larger the diameters of the fine pores can become.

### Step (e):

As illustrated in FIG. 1, by performing again the anode oxidation, the fine pores 36 with smaller diameter which are extended in downward direction from the bottom part of the cylindrical fine pores 36 are further formed.

The anode oxidation can be performed according to the same conditions as the step (a). As the longer the time for the anode oxidation is, the deeper fine pores can be obtained.

### Step (f):

As illustrated in FIG. 1, when the fine pore diameter-enlarging treatment in the step (d) and the anode oxidation in the step (e) are repeated, the anode oxidized porous alumina (an aluminum porous oxide film (alumite)), which has the fine pores 36 with a shape of which the diameter continuously decreases in the depth direction from the pore opening, is formed to give the mold 22 having an inverted micro-convexoconcave structure on its surface. The process is preferably ended with the step (d).

The number of the repetitions is preferably three or more in total, and more preferably five or more. If the number of repetitions is two or less, because the diameter of the fine pores decreases non-continuously, a reflectance-reducing effect of the cured layer prepared by using the anode oxidized porous alumina having such fine pores is insufficient.

Examples of the shape of the fine pores 36 include a substantially conical shape and a pyramidal shape.

The average period of the fine pores 36 is preferably the same or less than wavelength of visible light, that is, 400 nm or less, more preferably 200 nm or less, and particularly preferably 150 nm or less. Average period of the fine pores 36 is preferably 20 nm or more, and more preferably 25 nm or more.

The depth of the fine pores 36 is preferably 100 to 500 nm, more preferably 130 to 400 nm, and even more preferably 150 to 400 nm.

The aspect ratio of the fine pores 36 (depth of the fine pores/width of the opening of the fine pores) is preferably 1.0 or more, more preferably 1.3 or more, even more preferably 1.5 or more, and particularly preferably 2.0 or more. The aspect ratio of the fine pores 36 is preferably 5.0 or less.

The surface of the cured layer 20 which is formed by transferring the fine pores 36 as illustrated in FIG. 1 has a so-called moth eye structure.

The surface of the mold 22 may be treated with a release agent so as to have easy separation from a cured layer.

Examples of the release agent include silicone resins, fluorine resins, and fluorine compounds. From the viewpoint of good releasability and good adhesion to a mold body, fluorine compounds having a hydrolyzable silyl group are preferred. Examples of the commercial products of the fluorine compounds include fluoroalkyl silane, “OPTOOL” series manufactured by Daikin Industries, Ltd.

### (Active Energy Ray-Curable Resin Composition)

The active energy ray-curable resin composition contains a polymerizable compound and a polymerization initiator.

As for the active energy ray-curable resin composition, those containing, as a main component, a monomer to have a sufficiently small difference in refractive index between the base film and cured layer can be used.

Examples of the polymerizable compound include monomers, oligomers and reactive polymers having a radical polymerizable bond and/or a cationic polymerizable bond within the molecule.

The active energy ray-curable resin composition may also contain a non-reactive polymer or an active energy ray sol gel-reactive composition.

Examples of the monomer having a radical polymerizable bond include mono-functional monomers and polyfunctional monomers.

Examples of the mono-functional monomer include (meth)acrylate derivatives such as methyl (meth)acrylate, ethyl(meth)acrylate, propyl(meth)acrylate, n-butyl (meth)acrylate, i-butyl (meth)acrylate, s-butyl (meth)acrylate, t-butyl (meth)acrylate, 2-ethylhexyl(meth)acrylate, lauryl(meth)acrylate, alkyl(meth)acrylate, tridecyl(meth)acrylate, stearyl(meth)acrylate, cyclohexyl(meth)acrylate, benzyl (meth)acrylate, phenoxyethyl(meth)acrylate, isobornyl(meth)acrylate, glycidyl(meth)acrylate, tetrahydrofurfuryl(meth)acrylate, allyl(meth)acrylate, 2-hydroxyethyl(meth)acrylate, hydroxypropyl(meth)acrylate, 2-methoxyethyl(meth)acrylate, or 2-ethoxyethyl(meth)acrylate; (meth)acrylic acid and (meth)acrylonitrile; styrene and styrene derivatives such as α-methyl styrene; (meth)acrylamide and (meth)acrylamide derivatives such as N-dimethyl(meth)acrylamide, N-diethyl(meth)acrylamide; or dimethylaminopropyl(meth)acrylamide. These compounds may be used either singly or in combination of two or more.

Examples of the polyfunctional monomers include bifunctional monomers such as ethylene glycol di(meth)acrylate, tripropylene glycol di(meth)acrylate, ethylene oxide isocyanurate-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxyphenyl)propane, 2,2-bis(4-(meth)acryloxyethoxyphenyl)propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethyloltricyclodecane di(meth)acrylate, di(meth)acrylates of ethylene oxide adducts of bisphenol A, di(meth)acrylates of propylene oxide adducts of bisphenol A, neopentyl glycol hydroxypivalate di(meth)acrylate, divinylbenzene, or methylene bisacrylamide; trifunctional monomers such as pentaerythritol tri(meth)acrylate, trimethylolpropane tri(meth)acrylate, ethylene oxide-modified tri(meth)acrylates of trimethylolpropane, propylene oxide-modified triacrylates of trim ethylolpropane, ethylene oxide-modified triacrylates of trimethylolpropane, or ethylene oxide isocyanurate-modified tri(meth)acrylate; tetra- or higher functional monomers, such as condensation reaction mixtures of succinic acid/trimethylol ethane/acrylic acid, dipentaerythritol hexa(meth)acrylate, dipentaerythritol penta(meth)acrylate, ditrimethylol propane tetraacrylate, or tetramethylol methane tetra(meth)acrylate; and bi- or higher functional urethane acrylates and bi- or higher functional polyester acrylates. These compounds may be used either singly or in combination of or two or more.

Examples of the monomer having a cationic polymerizable bond include monomers having an epoxy group, an oxetanyl group, an oxazolyl group, or a vinyl oxy group, and the monomers having an epoxy group are particularly preferable.

Examples of the oligomer or reactive polymer include unsaturated polyesters such as condensation products of unsaturated dicarboxylic acid and polyhydric alcohol; polyester(meth)acrylate, polyether(meth)acrylate, polyol(meth)acrylate, epoxy(meth)acrylate, urethane(meth)acrylate, cationic polymerizable epoxy compounds; and homopolymers or copolymers of the above monomers having a radical polymerizable bond on a side chain thereof.

Examples of the non-reactive polymer include an acrylic resin, a styrene resin, polyurethane, a cellulose resin, polyvinyl butyral, polyester, and a thermoplastic elastomer.

Examples of the active energy ray sol-gel reactive composition include an alkoxysilane compound and an alkylsilicate compound.

Examples of the alkoxysilane compound include a compound represented by the following formula (1).

R¹ₓSi(OR²)_{y} (1)

With the proviso that, each of R¹ and R² represents an alkyl group with 1 to 10 carbon atoms, and x and y represent an integer which satisfies the relationship of x+y=4.

Examples of the alkoxysilane compound include tetramethoxysilane, tetra-i-propoxysilane, tetra-n-propoxysilane, tetra-n-butoxysilane, tetra-sec-butoxysilane, tetra-t-butoxysilane, methyltriethoxysilane, methyltripropoxysilane, methyltributoxysilane, dimethyl dimethoxysilane, dimethyl diethoxysilane, trimethylethoxysilane, trimethylmethoxysilane, trimethylpropoxysilane, and trimethylbutoxysilane.

Examples of the alkoxysilicate compound include a compound represented by the following formula (2).

R³O[Si(OR⁵)(OR⁶)O]_{z}R⁴ (2)

With the proviso that, each of R³ to R⁶ represents an alkyl group with 1 to 5 carbon atoms, and z represents an integer of from 3 to 20.

Examples of the alkylsilicate compound include methyl silicate, ethyl silicate, isopropyl silicate, n-propyl silicate, n-butyl silicate, n-pentyl silicate, and acetyl silicate.

In the case of using a photo-curing reaction, examples of the photopolymerization initiator include carbonyl compounds such as benzoin, benzoin methyl ether, benzoin ethyl ether, benzoin isopropyl ether, benzoin isobutyl ether, benzyl, benzophenone, p-methoxybenzophenone, 2,2-diethoxyacetophenone, α,α-dimethoxy-α-phenylacetophenone, methyl phenylglyoxylate, ethyl phenylglyoxylate, 4,4′-bis(dimethylamino)benzophenone, or 2-hydroxy-2-methyl-1-phenylpropan-1-one; sulfur compounds such as tetramethylthiuram monosulfide or tetramethylthiuram disulfide; 2,4,6-trimethylbenzoyl diphenylphosphine oxide; and benzoyl diethoxyphosphine oxide. These compounds may be used either singly or in combination of two or more.

In the case of using an electron beam curing reaction, examples of the polymerization initiator include benzophenone, 4,4-bis(diethylamino)benzophenone, 2,4,6-trimethylbenzophenone, methyl ortho-benzoylbenzoate, 4-phenylbenzophenone, t-butylanthraquinone, 2-ethyl anthraquinone, thioxanthones such as 2,4-diethylthioxanthone, isopropylthioxanthone, or 2,4-dichlorothioxanthone; acetophenones such as diethoxyacetophenone, 2-hydroxy-2-methyl-1-phenylpropan-1-one, benzyl dimethyl ketal, 1-hydroxycyclohexyl phenyl ketone, 2-methyl-2-morpholino(4-thiomethylphenyl)propan-1-one, or 2-benzyl-2-dimethylamino-1-(4-morpholinophenyl)-butanone; benzoin ethers such as benzoin methyl ether, benzoin ethyl ether, benzoin isopropyl ether, or benzoin isobutyl ether; acylphosphine oxides such as 2,4,6-trimethylbenzoyl diphenylphosphine oxide, bis(2,6-dimethoxybenzoyl)-2,4,4-trimethylpentylphosphine oxide, or bis(2,4,6-trimethylbenzoyl)-phenylphosphine oxide; and methylbenzoyl formate, 1,7-bisacridinylheptane, and 9-phenylacridine. These compounds may be used either singly or in combination of two or more.

In the case of using a thermal curing reaction, examples of the thermal polymerization initiator include an organic peroxide such as methyl ethyl ketone peroxide, benzoyl peroxide, dicumyl peroxide, t-butyl hydroperoxide, cumene hydroperoxide, t-butyl peroxyoctoate, t-butyl peroxybenzoate, or lauroyl peroxide; an azo compound such as azobis isobutyronitrile; and a redox polymerization initiator in which the aforementioned organic peroxide is combined with an amine such as N,N-dimethyl aniline or N,N-dimethyl-p-toluidine. These polymerization initiators may be used in combination.

The content of the polymerization initiator is preferably 0.1 to 10 parts by mass based on 100 parts by mass of the polymerizable compound. When the content of the polymerization initiator is less than 0.1 part by mass, the polymerization proceeds poorly. On the other hand, when the content of the polymerization initiator exceeds 10 parts by mass, there are cases where the cured resin layer is colored or mechanical strength is impaired.

If required, the active energy ray-curable resin composition may also include an additive such as an anti-static agent, a release agent, or a fluorine compound for improving an anti-fouling effect, microparticles, or a small amount of solvent.

The active energy ray-curable resin composition is an important factor for deciding the adhesiveness at an interface between the cured layer and base film. It is known that, based on an anchor effect that the active energy ray-curable resin composition penetrates into irregularities of a base film, the adhesiveness at an interface between the cured layer and base film is improved. The penetrating property varies depending on the type of the active energy ray-curable resin composition, and in general, a mono-functional monomer or a bi-functional monomer having a low molecular weight tends to have a higher penetrating property into irregularities of a base film. As such, in order to improve the adhesiveness at an interface between the cured layer and base film, it is preferable to use a mono-functional monomer or a bi-functional monomer having a low molecular weight, and an optimum monomer can be suitably selected depending on the type of a base film. Meanwhile, a mono-functional monomer or a bi-functional monomer having a low molecular weight indicates a mono-functional monomer or a bi-functional monomer having molecular weight of 300 or less. The active energy ray-curable resin composition preferably contains the low molecular weight component preferably at 7% by mass or more, and more preferably at 10% by mass or more.

In the active energy ray-curable resin composition, a polyfunctional (meth)acrylate monomer and a bi-functional monomer or a mono-functional monomer are used in combination. As the polyfunctional (meth)acrylate monomer tends to have high viscosity, the handling property may be deteriorated. Even for such a case, by dilution with a monofuncitional monomer or bi-functional monomer with low viscosity, the handling property can be improved.

In order to enhance the adhesiveness at an interface between the cured layer and base film, a monofunctional monomer such as alkyl(meth)acrylates or hydroxyalkyl(meth)acrylates is preferable. Further, a viscosity modifying agent such as bi-functional alkyl(meth)acrylates, acryloyl morpholine, or vinyl pyrrolidone, and acryloyl isocyanates may be also used. For example, when an acrylic resin is used as a material of a base film, it is particularly preferable to use methyl(meth)acrylate or ethyl acrylate.

### (Production Apparatus)

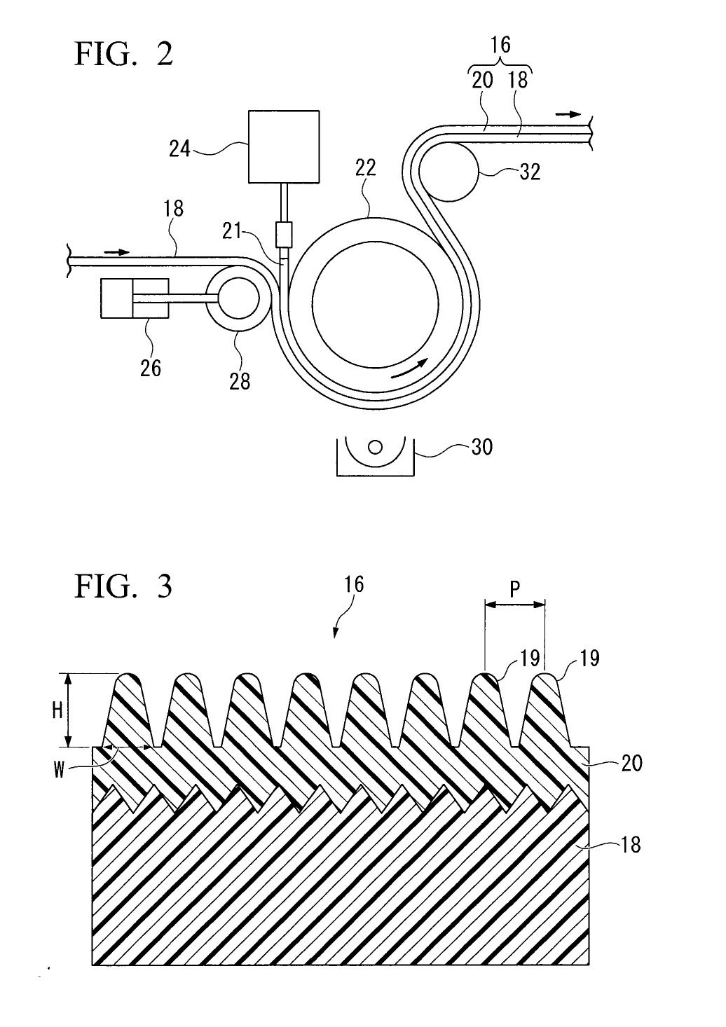

The transparent film is produced, for example, as follows by using a production apparatus illustrated in FIG. 2.

Between a surface of the roll-shaped mold 22 having an inverted fine structure consisting of plural fine pores (not illustrated) on a surface thereof and a rough surface of the strip-shaped base film 18 moving along the surface of the mold 22 which is synchronous to rotation of the mold 20, the active energy ray-curable resin composition 21 is supplied from the tank 24.

Between the mold 22 and the nip roll 28 for which the nip pressure is adjusted by the pneumatic pressure cylinder 26, the base film 18 and the active energy ray-curable resin composition 21 are nipped, and at the same time of spreading the active energy ray-curable resin composition 21 uniformly between the base film 18 and the mold 22, the composition is filled inside the fine pores of the mold 22.

While the active energy ray-curable resin composition 21 is sandwiched between the mold 22 and the base film 18, by irradiating the active energy ray-curable resin composition 21 from the base film 17 side with the active energy ray from the active energy ray irradiation apparatus 30 installed below the mold 22 to cure the active energy ray-curable resin composition 21, the cured layer 20, to which plural fine pores (concave sections) on a surface of the mold 22 have been transferred, is formed.

By separating the base film 18, on which the cured layer 20 has been formed on the surface thereof, with the separating roll 32, a transparent film 16 is obtained.

When the active energy ray-curable resin composition 21 is supplied between the mold 22 and the base film 18 and the active energy ray-curable resin composition 21 is cured, the surface of the mold 22 is preferably adjusted to 70° C. or higher. By having it at 70° C. or higher, viscosity of the active energy ray-curable resin composition 21 is lowered and it can be easily incorporated to the concave sections of the base film 18 having a rough surface, and thus a sufficient adhesiveness is obtained. From the viewpoint of promoting an anchor effect for the active energy ray-curable resin composition 21 to penetrate into the irregularities of the base film 18 for enhancing the adhesiveness, temperature of the mold 22 is preferably even higher. It is more preferably 75° C. or higher, and even more preferably 80° C. or higher. Further, from the viewpoint of suppressing a decrease in mechanical strength or a shrinkage of the base film 18, the temperature of the mold 22 is preferably 100° C. or lower, and more preferably 95° C. or lower.

During the time period from irradiation of active energy ray to curing while the active energy ray-curable resin composition 21 is sandwiched between the mold 22 and the base film 18, by extending the time during which the base film 18 is in contact with the active energy ray-curable resin composition 21, the anchor effect for penetration of the active energy ray-curable resin composition 21 into the irregularities of the base film 18 is promoted so that the adhesiveness can be improved.

As the active energy ray irradiation apparatus 30, a high-pressure mercury lamp, a metal halide lamp, or the like is preferred. The amount of the photo-irradiation energy in this case is preferably 100 to 10000 mJ/cm².

### <Transparent Film>

The transparent film 16 obtained as above has, as illustrated in FIG. 3, the base film 18 and the cured layer 20 having a micro-convexoconcave structure consisting of plural convex section 19, that is formed on a rough surface of the base film 18.

As for the plural convex section 19, a so-called moth eye structure is preferred, in which plural projections (convex sections) having a substantially conical shape, pyramidal shape, or the like are arranged at an interval equal to or less than the wavelength of visible light. The moth eye structure is known to be an effective anti-reflective means as the refractive index is continuously increased from the refractive index of air to the refractive index of the material.

The average period of the convex section 19 is preferably equal to or less than the wavelength of visible light, namely 400 nm or less, more preferably 200 nm or less, and particularly preferably 150 nm or less. Herein, the average period of the convex section 19 is determined by measuring the interval P between adjacent convex section 19 (the distance from the center of the convex section 19 to the center of the adjacent convex section 19) at 5 points by electron microscope observation of the cross-section of the cured layer 20, followed by averaging those values.

The average period of the convex section 19 is preferably 100 nm or so when the convex section 19 is formed by using a mold of anode oxidized porous alumina.

In addition, from the viewpoint of facilitating formation of the convex section 19, the average period of the convex section 19 is preferably 20 nm or more, and more preferably 25 nm or more.

The ratio between the height H of the convex section 19 and the bottom part width W of the convex section 19, that is, H/W, is preferably 1.0 or more, more preferably 1.3 or more, even more preferably 1.5 or more, and particularly preferably 2.0 or more. When H/W is 1.0 or more, the reflectance ratio can be suppressed at low level in the whole range covering from visible ray range to infrared ray range. H/W is preferably 5.0 or less from the viewpoint of the mechanical strength of the convex section 19.

H is preferably 100 to 500 nm, more preferably 130 to 400 nm, and even more preferably 150 to 400 nm. When the height of the convex section 19 is 100 nm or more, the reflectance ratio is sufficiently lowered and also the reflectance ratio has a weak wavelength dependency. When the height of the convex section 19 is 500 nm or less, the mechanical strength of the convex section 19 is improved.

H and W can be measured by observing the cross-section of the cured layer 20 with an electron microscope. W is the width of a plane which is identical to the lowest part of the concave section formed around the convex section 19 (hereinbelow, the plane is described as a standard plane).

H is taken as the height from the standard plane to the uppermost part of the convex section 19.

H/W can be controlled by suitably selecting a condition for producing a mold having anode oxidized porous alumina on its surface, viscosity of an active energy ray-curable resin composition to be filled in fine pores (that is, concave sections) of the mold (see, JP 2008-197216 A), or the like.

When the moth eye structure is contained on the surface, it is known that super water repellency is obtained due to the lotus effect if the surface is made of a hydrophobic material, while super hydrophilicity is obtained if the surface is made of a hydrophilic material.

The water contact angle of the moth eye structure for a case in which the material of the cured layer 20 is hydrophobic is preferably 90° or higher, more preferably 100° or higher, and particularly preferably 110° or higher. When the water contact angle is 90° or higher, water contamination cannot be easily adhered so that a sufficient anti-fouling property is exhibited. Further, as water is not easily adhered, it is expected to prevent icing.

The water contact angle of the moth eye structure for a case in which the material of the cured layer 20 is hydrophilic is preferably 25° or lower, more preferably 23° or lower, and particularly preferably 21° or lower. When the water contact angle is 25° or lower, contamination adhered on the surface is washed with water and also, as oil contamination cannot be easily adhered, a sufficient anti-fouling property is exhibited. The water angle is preferably 3° or higher from the viewpoint of suppressing a deformation of the moth eye structure caused by water absorption in the cured layer 20 and an increase in the reflectance ratio accompanying therewith.

### (Product Having Micro-Convexoconcave Structure on Surface Thereof)

By applying the transparent film on a main body of various products, a product having a micro-convexoconcave structure on surface thereof is obtained.

Examples of the material of the main body of a product include glass, acrylic resin, polycarbonate, styrene resin, polyester, cellulose resin (triacetyl cellulose, and so on), polyolefin, and alicyclic polyolefin.

Examples of the product having a micro-convexoconcave structure on a surface thereof include an optical product such as an anti-reflection product (anti-reflection film, anti-reflection membrane), a waveguide, a relief hologram, a lens, or a polarization separator, a sheet for cell culture, a super water-repellant film, and a super-hydrophilic film. It is particularly preferred for the use as an anti-reflection product. Examples of the anti-reflection product include an anti-reflection membrane, an anti-reflection film, and an anti-reflection sheet that are used on a surface of image display devices such as liquid crystal display devices, plasma display panels, electroluminescent displays, or cathode tube display devices, display devices such as service meter, a protection plate of a solar cell, a transparent substrate for a transparent electrode, lens, show window, display case, front board of a lighting, or glasses.

### (Adhesiveness)

The adhesiveness at an interface between the cured layer and base film can be evaluated by a cross cut test or the like using 100 lattices at an interval of 2 mm according to JIS K 5400. As for the adhesiveness, with the cross cut test or the like in which 100 lattices at an interval of 2 mm are used according to JIS K 5400, the lattice number of 51 or higher in the cured layer adhered to the base film is preferable. The lattice number of 60 or higher is more preferable, and the lattice number of 70 or higher is even more preferable. When the adhered lattice number is 51 or higher, unintended peeling of the cured layer from the base film, which occurs when a product having a micro-convexoconcave structure on a surface thereof is used for an anti-reflection product or the like, can be suppressed.

### (Working Effects)

According to the method for producing a transparent film of the present invention explained above, in the production method having (I) a step of sandwiching an active energy ray-curable resin composition between a surface of a base film and a surface of a mold having an inverted structure of a micro-convexoconcave structure, (II) a step of irradiating the active energy ray-curable resin composition with an active energy ray to cure the active energy ray-curable resin composition, thus forming a cured resin layer and obtaining a transparent film, and (III) a step of separating the transparent film and the mold, as a base film, the one having a rough surface in which the maximum valley depth Pv is 0.1 to 3 μm and the average length RSm of a contour curve element is 10 μm or less is used, and thus the cured layer can penetrate into the irregularities of the base film, and due to an anchor effect, the adhesiveness at an interface between the cured layer and base film is improved. Further, as the irregularities of the base film are completely filled by the cured layer, an appearance defect can be prevented. As a result, good adhesiveness is obtained at an interface between the cured layer and base film, and therefore a transparent film with good appearance quality can be produced stably.

### EXAMPLES

Hereinbelow, the present invention is specifically explained in view of the examples, but the present invention is not limited to them.

### (Pores of Anode Oxidized Porous Alumina)

A part of the anode oxidized porous alumina was cut, and platinum was deposited on its cross-section for one minute. The field emission shape scanning electron microscope (manufactured by JEOL, JSM-7400F) was used under the conditions of the accelerating voltage: 3.00 kV to observe the cross-section and measure the pore interval and the depth of the pores. Each measurement was performed for each of 50 points, and the average value was obtained.

### (Convex Section of Cured Layer)

Platinum was deposited on a fracture surface of the cured layer for five minutes. The field emission shape scanning electron microscope (manufactured by JEOL, JSM-7400F) was used under the conditions of the accelerating voltage: 3.00 kV to observe the cross-section and measure the average interval and the depth of the convex section. Each measurement was performed for each of 5 points, and the average value was obtained.

### (Refractive Index)

The refractive index of the base film and cured layer was measured by using ABBE refractometer (manufactured by ATAGO CO., LTD., NAR-2).

### (Surface Roughness)

The maximum valley depth Pv and the average length RSm of a contour curve element of the base film are based on JIS B 0601: 2001, and the observation was made by using a scanning type white light interferometer three-dimensional profiler system “New View 6300” (manufactured by Zygo Corporation). The visible ranges are connected to each other to have a size of 4 mm×0.5 mm, and it was obtained from the observation result.

### (Adhesiveness)

With regard to the adhesiveness at an interface between the cured layer and the base film, a cross cut test was performed according to JIS K 5400 by using 100 lattices that are at an interval of 2 mm. The evaluation was based according to the following criteria.

⊙: All of 100 lattices are closely adhered to each other.
◯: Number of lattices closely adhered to each other is 91 to 99 in 100 lattices.
Δ: Number of lattices closely adhered to each other is 51 to 90 in 100 lattices.
X: Number of lattices closely adhered to each other is 0 to 50 in 100 lattices.

### (Appearance)

With regard to the appearance, those obtained by applying a transparent film to both sides of an acrylic plate were examined by a naked eye determination and also under an optical microscope, and the evaluation was based according to the following criteria.

◯: The area of defective section is less than 1% compared to entire area.
X: The area of defective section is the same or more than 1% compared to entire area.

### (Method for Producing Mold a)

A cylindrical aluminum base obtained by cutting an aluminum ingot of 99.99% purity to have diameter of 200 mm and length of 350 mm, which has no sign of rolling, was subjected to a fabric polishing treatment and then mirror-polished according to electrolytic polishing in a mixture solution of perchloric acid/ethanol mixture (volume ratio: 1/4).

Step (a):

In 0.3 M aqueous solution of oxalic acid, anode oxidation of the mirror-polished aluminum base was performed for 30 minutes under the conditions of DC: 40 V and temperature: 16° C.

Step (b):

The aluminum base formed with the oxide film having thickness of 3 μm was immersed in a mixed aqueous solution of 6% by mass phosphoric acid/1.8% by mass chromic acid to remove the oxide film.

Step (c):

In 0.3 M aqueous solution of oxalic acid, anode oxidation of the aluminum base with removed oxide film was performed for 30 seconds under the conditions of DC: 40 V and temperature: 16° C.

Step (d):

The aluminum base formed with the oxide film was immersed in an aqueous solution of 5% by mass phosphoric acid for 8 minutes at 32° C., so as to perform the pore diameter-expanding treatment.

Step (e):

In 0.3 M aqueous solution of oxalic acid, anode oxidation of the aluminum base obtained after pore diameter-expanding treatment was performed for 30 seconds under the conditions of DC: 40 V and temperature: 16° C.

Step (f):

The previous Step (d) and Step (e) were repeatedly performed for 4 times in total and ended with Step (d), so as to obtain the roll-shaped Mold a having the substantially cone shaped pores with the average period of 100 nm and depth of 180 nm formed on the surface thereof.

Mold a was immersed for 10 minutes in 0.1% by mass diluted solution of OPTOOL DSX (manufactured by Daikin Industries) and then taken out. After air drying overnight, Mold a treated with a release agent was obtained.

### (Preparation of Active Energy Ray-Curable Resin Composition)

The active energy ray-curable resin composition A having the following composition was prepared (Table 1).

TABLE 1

| | Parts | Molec- |
|---|---|---|
| | by | ular |
| Composition | mass | weight |
| Mixed product of condensed reaction of succinic acid/ | 45 | 538 |
| trimethylol ethane/acrylic acid (molar ratio 1:2:4) | | |
| 1,6-Hexanediol diacrylate (manufactured by | 45 | 254 |
| OSAKA ORGANIC CHEMICAL INDUSTRY LTD) | | |
| Radical polymerizable silicone oil (manufactured by | 10 | 4000 |
| Shin-Etsu Chemical Co., Ltd., X-22-1602) | | |
| 1-Hydroxycyclohexyl phenyl ketone | 3 | — |
| (manufactured by Ciba Specialty Chemicals Corp., | | |
| IRAGACURE (registered trademark) 184) | | |
| Phenyl bis(2,4,6-trimethylbenzoyl)phosphine oxide | 0.2 | — |
| (manufactured by Ciba Specialty Chemicals Corp., | | |
| IRAGACURE (registered trademark) 819) | | |
| Phosphoric acid ester-based release agent | 0.1 | — |
| (manufactured by Axel Corporation, MoldWiz | | |
| INT-1856) | | |

The cured layer having thickness of 5 μm, which has been obtained by curing the active energy ray-curable resin composition A, is transparent and has refractive index of 1.51.

The active energy ray-curable resin composition B having the following composition was prepared (Table 2).

TABLE 2

| | Parts | Molec- |
|---|---|---|
| | by | ular |
| Composition | mass | weight |
| Mixed product of condensed reaction of succinic acid/ | 60 | 538 |
| trimethylol ethane/acrylic acid (molar ratio 1:2:4) | | |
| Polyethylene glycol diacrylate (manufactured by | 30 | 664 |
| Toagosei Company, Limited, ARONIX M-260) | | |
| Methyl acrylate (manufactured by | 5 | 86 |
| Mitsubishi Chemical Corporation) | | |
| 1-Hydroxycyclohexyl phenyl ketone (manufactured | 1 | — |
| by Ciba Specialty Chemicals Corp., IRAGACURE 184) | | |
| Phenyl bis(2,4,6-trimethylbenzoyl)phosphine oxide | 0.1 | — |
| (manufactured by Ciba Specialty Chemicals Corp., | | |
| IRAGACURE 819) | | |
| Phosphoric acid ester-based release agent | 0.3 | — |
| (manufactured by Axel Corporation, INT-1856) | | |

The cured layer having thickness of 5 μm, which has been obtained by curing the active energy ray-curable resin composition B, is transparent and has refractive index of 1.52.

### (Surface Roughening of Base Film)

An acrylic film (manufactured by Mitsubishi Rayon Co., Ltd., trade name: ACRYPREN (registered trademark) HBK003, thickness: 100 μm, refractive index: 1.49, loss coefficient tan δ of dynamic viscoelasticity: 104° C., total light transmission: 92.6%, haze: 0.63%, transmission for light with wavelength of 365 nm: 91%) was prepared.

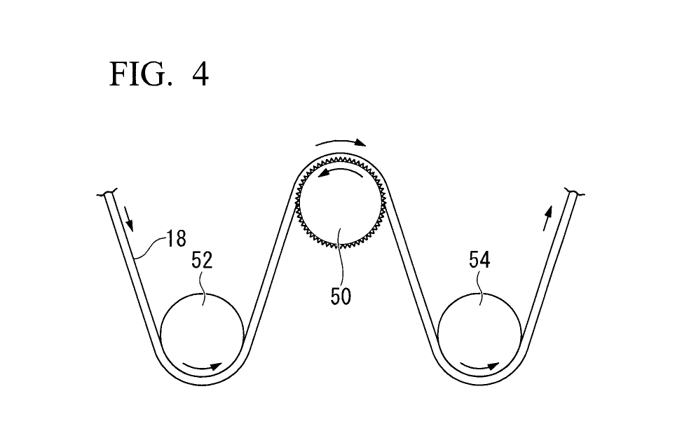

By rotating the blast roll 50 in an opposite direction to the moving direction of the base film 18, the surface of the acrylic film was roughened by using a scratch blast apparatus having the brush roll 50 with an irregular shape consisting of titan oxide on its surface and the tension roll 52 and 54 that are disposed before and after the brush roll 50 as illustrated in FIG. 4. By changing the tension applied to the base film 18 by means of the tension roll 52 and 54, an acrylic film having adjusted surface roughness was obtained. The maximum valley depth Pv and average length RSm of a contour curve element are illustrated in Table 3.

### Example 1

A transparent film was produced by using the production apparatus illustrated in FIG. 2.

As for the roll-shaped mold 22, the aforementioned Mold a was used.

As for the active energy ray-curable resin composition 21, the active energy ray-curable resin composition A shown in Table 1 was used.

As for the base film 18, the acrylic film having the maximum valley depth Pv and average length RSm of a contour curve element that are shown in Table 3 was used. Further, values of the maximum height roughness Rz (based on JIS B 0601: 2001) are described for reference.

From the base film 18 side, UV ray with accumulated light amount of 1000 mJ/cm² was irradiated onto the coated film of the active energy ray-curable resin composition A for performing the curing of the active energy ray-curable resin composition A. At the time of curing the active energy ray-curable resin composition A, the surface temperature of the Mold a was 70° C.

The average period of the convex section in the obtained transparent film was 100 nm and the height of the convex section was 180 nm. The results of evaluating adhesiveness and appearance of the transparent film are shown in Table 3.

### Examples 2 to 6 and Comparative Examples 1 and 2

The transparent film was produced in the same manner as Example 1 except that those shown in Table 3 are used as the active energy ray-curable resin composition 21 and the base film 18 and the temperature of the mold 22 is changed.

The results of evaluating adhesiveness and appearance of the transparent film are shown in Table 3.

TABLE 3

| | | Maximum | Average | | | | | | |
|---|---|---|---|---|---|---|---|---|---|
| | | valley depth | length of | Maximum | | | | | |
| | | of base | contour curve | height | | Mold | | | |
| | | film, | element of | roughness of | | temperature | Cross- | Adhesiveness | |
| | | Pv [μm] | base film, RSm [μm] | base film, Rz [μm] | Composition | (° C.) | cut test | evaluation | Appearance |
| Examples | 1 | 2.56 | 3.9 | 0.81 | A | 70 | 100/100 | ⊙ | ◯ |
| | 2 | 0.13 | 5.8 | 0.10 | A | 73 | 92/100 | ◯ | ◯ |
| | 3 | 1.61 | 4.1 | 0.28 | A | 82 | 100/100 | ⊙ | ◯ |
| | 4 | 1 | 8.3 | 0.90 | A | 75 | 98/100 | ◯ | ◯ |
| | 5 | 0.59 | 4.9 | 0.23 | A | 62 | 65/100 | Δ | ◯ |
| | 6 | 1.17 | 4.2 | 0.70 | B | 71 | 80/100 | Δ | ◯ |
| Comparative | 1 | 3.43 | 3.5 | 1.10 | A | 82 | 100/100 | ⊙ | X |
| exampls | 2 | 0.46 | 14 | 0.17 | A | 72 | 30/100 | X | ◯ |

### INDUSTRIAL APPLICABILITY

The transparent film of the present invention is useful as an anti-reflection product or the like.

### EXPLANATIONS OF LETTERS OR NUMERALS

16 Transparent film
18 Base film
19 Convex section (micro-convexoconcave structure)
20 Cured layer
21 Active energy ray-curable resin composition
22 Mold
36 Pores (inverted structure)

1. A transparent film comprising:
a cured layer,
wherein the cured layer having a micro-convexoconcave structure with the average period of a convex section or a concave section of 20 nm to 400 nm is formed on a rough surface of a base film obtained from an acrylic resin having a rough surface in which a maximum valley depth (Pv) is 0.1 to 3 μm and an average length (RSm) of a contour curve element is 10 μm or less; and
the number of lattice in the cured layer adhered to the base film is 51 or more when a cross cut test is performed using 100 lattices at an interval of 2 mm.

2. A method for producing a transparent film with a cured layer having a micro-convexoconcave structure formed on a surface of a base film, the method comprising:
(I) a step of sandwiching an active energy ray-curable resin composition between a rough surface of a base film obtained from an acrylic resin having a rough surface in which a maximum valley depth (Pv) is 0.1 to 3 μm, and an average length (RSm) of a contour curve element is 10 μm or less and a surface of a mold having an inverted structure of a micro-convexoconcave structure;
(II) a step of irradiating the active energy ray-curable resin composition with an active energy ray to cure the active energy ray-curable resin composition, thus forming a cured layer and obtaining a transparent film; and
(III) a step of separating the transparent film and the mold.

3. The method for producing a transparent film according to claim 2, wherein, in the step (II) above, a surface temperature of the mold is 70° C. or higher at the time of curing the active energy ray-curable resin composition.

4. The method for producing a transparent film according to claim 2, wherein the mold has, on its surface, a micro-convexoconcave structure in which an average period of the convex section or concave section is 20 nm to 400 nm.

5. The method for producing a transparent film according to claim 4, wherein the micro-convexoconcave structure of the mold is anode oxidized porous alumina.

6. A base film obtained from an acrylic resin being used for producing a transparent film with a cured layer having a micro-convexoconcave structure formed on its surface,
wherein the base film has a rough surface with a maximum valley depth (Pv) of 0.1 to 3 μm, and an average length (RSm) of a contour curve element of 10 μm or less.
